(19) United States
(12) Patent Application Publication
(10) Pub. No.: US 2023/0005230 A1
(43) Pub. Date: Jan. 5, 2023

(54) EFFICIENT STORAGE, REAL-TIME RENDERING, AND DELIVERY OF COMPLEX GEOMETRIC MODELS AND TEXTURES OVER THE INTERNET

(71) Applicant: Cylindo ApS, Copenhagen (DK)

(72) Inventors: Jens Fersund, Virum (DK); Andreas Møller, Valby (DK)

(21) Appl. No.: 17/552,102

(22) Filed: Dec. 15, 2021

Related U.S. Application Data
(60) Provisional application No. 63/218,121, filed on Jul. 2, 2021.

(51) Int. Cl. G06T 19/20; G06T 15/20; G06T 15/04; G06T 15/40; G06T 15/60; G06T 15/06

(52) U.S. Cl. CPC G06T 19/20; G06T 15/20; G06T 15/04; G06T 15/40; G06T 15/60; G06T 15/06; G06T 2219/2004

(57) ABSTRACT

A method for real-time compositing, rendering and delivery of complex geometric models and textures, includes storing a plurality of three-dimensional models of at least two sub-parts of a whole three-dimensional object, storing a plurality of image textures for each of the plurality of three-dimensional models, receiving instructions from a user, the instructions including a selection of at least two of the plurality of three-dimensional models, each of the at least two of the plurality of three-dimensional models being one of the at least two sub-parts of the whole three-dimensional object, and generating the whole three-dimensional object including the at least one of the plurality of image textures for each of the at least two of the plurality of three-dimensional models applied according to the instructions to the at least two of the plurality of three-dimensional models.

### RELATED APPLICATION INFORMATION

This patent claims priority from U.S. provisional patent application No. 63/218,121 entitled “EFFICIENT STORAGE, REAL-TIME RENDERING AND DELIVERY OF COMPLEX GEOMETRIC MODELS AND TEXTURES OVER THE INTERNET” filed Jul. 2, 2021, the entire content of which is incorporated herein by reference.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

### Field

This disclosure relates to storage and delivery of complex geometric models and textures over the internet.

### Description of the Related Art

There exist some datasets that are particularly difficult or impossible to easily share over the internet. Since the advent of the internet for public consumption in the early 1990s, storage capability and bandwidth have dramatically increased. Where downloading a single 4-megabyte MP3 file used to take minutes or hours (depending on the type of connection), it now takes seconds for most Americans and many users worldwide. Likewise, where digital video discs (DVDs) with capacities of approximately 4 gigabytes were needed to contain the voluminous data for film and television programs, now encoding techniques and increased bandwidth have enabled entire neighborhoods to concurrently stream video content from services like Netflix® and Hulu® over standard home internet services.

Despite all of these advances in both storage and data transmission, there still exist some datasets that are too costly, too slow, too large, or too complex to be stored on a server and/or easily transmitted over the internet on demand. These datasets are atypical. They are not ones commonly considered by most consumers or most personal computer or mobile device users. The problems presented by these types of datasets are not often confronted, precisely because they are rare. As a result, the solutions for delivery of these types of datasets are likewise not common or even available.

One example of such a dataset is high-quality images of customizable furniture. As many have experienced when shopping for virtually any item online, there tends to be between one to ten images of that item, often from various perspectives, but sometimes from only a few. Furniture, particularly high-quality and custom furniture (e.g., where one can select particular legs, fabrics, arms, etc.) is a major purchase for many. When making those purchases, many wish to see the product, or the potential product, as closely as possible to its end form. Home designers and professional decorators carefully craft an entire home or room design. Having only a few views is unacceptable. Because the furniture is custom (in whole or in part), there may literally never yet have been a created, real-world example of a design proposed by the designer.

In a pre-internet world given this situation, a designer would travel to a location where swatches of fabric and example arms and designs would be available, and he or she would combine the elements in near proximity to one another and “guess” what the resulting appearance would be. An experienced designer could become quite good at this type of work. Some customers or homeowners are able to do this mental exercise as well, but many are unable to do this kind of imagining and have difficulty picturing how their proposed new furniture will fit into their environment.

There may be literally hundreds of potential fabrics, multiple “backs” for a given chair or sofa, tens or hundreds of “arms,” various legs, and so on. Some of the more complex furniture to which the systems described herein are applied have resulted in as many as 40,000 different permutations of elements, fabrics, materials and the like for a single piece of furniture. In that context, it is literally impossible to store images for all of the different fabric texture, arm, leg, back, and the like combinations that are possible for that piece of furniture. The data capacity necessary would be astronomical. Multiply this by many different views of a particular piece (e.g. from different sides and angles) and the many various pieces of furniture in a given collection or available from a manufacturer, and the result only compounds.

Furthermore, designers wish to view the furniture from any one of many perspectives, potentially even an augmented reality (AR) perspective allowing full range of movement around an object. Providing only a front view or even a perspective view or both is insufficient. The designer may wish to see it from any number of perspectives or many perspectives before making a decision on a given design. So, the resulting need of images 360 degrees around a piece in addition to all of the permutations on design and fabric result in an untenable amount of data for storage and transmission. One option is to rely upon three-dimensional rendering in real time, but that requires substantial processing power, is difficult to cause the furnishings to appear photorealistic on all but the best computing devices, and it is difficult to scale such a process while responding to potentially hundreds or thousands of web requests at once in real time. In addition, simply transmitting a three-dimensional model and associated textures is time-consuming because they are larger than typical two-dimensional images used in most web browsing. The web browsing experience then bogs down and becomes unenjoyable or impossible for a consumer. As most sellers know, any impediment to a sale (such as slow responsiveness of a website) is a bad thing.

The foregoing example is made with respect to furniture because it is one example that is familiar to the patentee and in which the patentee's technology has been effective at resolving difficult problems. However, other situations exist in which complex geometry and high-quality textures meet with a need for delivery of multiple perspectives on the object. Automotive purchases, especially high-end automotive, custom clothing, architecture, and other industries can rely upon similar functionality as discussed herein to some similar, if not identical, problems.

### DESCRIPTION OF THE DRAWINGS

The patent application file contains at least one drawing to be executed in color. Copies of this patent application publication with color drawings will be provided by the Office upon request and payment of the necessary fee.

FIG. 1 is an overview of a system for efficient storage, real-time rendering, and delivery of complex geometric models and textures over the internet.

FIG. 2 is a block diagram of an exemplary computing device.

FIG. 3 is a functional block diagram of a system for efficient storage, real-time rendering, and delivery of complex geometric models and textures over the internet.

FIG. 4 is an example three-dimensional model of an object presented in wireframe.

FIG. 5 is an example three-dimensional model with the wireframes interconnected by triangles.

FIG. 6 is an example three-dimensional model covered in a particular material and an associated texture.

FIG. 7 is an example of the multiple components making up a given object.

FIG. 8 is an example flow for compositing a two-dimensional image from a series of components as layers.

FIG. 9 is an example flow for compositing a three-dimensional, textured model from components as layers.

FIG. 10 is a flowchart of a process for efficient storage, real-time rendering, and delivery of complex geometric models and textures over the internet.

FIG. 11 is a flowchart of a process for generating dynamic three-dimensional models and textures.

FIG. 12 is a flowchart of a process for applying realistic lighting effects to a generated three-dimensional model.

FIG. 13 is a flowchart of a process for applying appropriate visual warp to translucent and transparent three-dimensional models.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

In response to these issues, the patentee has created a system for two-dimensional compositing of images wherein, for a particular design, the individual components are saved (e.g., their shape) in the form of a 2D image. The associated textures (e.g., fabric, or wood color for legs or arms) are stored in a known format. The 2D images are stored for each of 32 different points of “rotation” about the object. So, for example, 32 different views of a chair base (with no arms or legs, etc.) and 32 different views of each type of leg, each type of arm, each type of back, etc. These images are basically stored “blank” for purposes of texture, enabling application of textures after-the-fact. This reduces the need to have full images with every texture for every permutation. The images that are only parts of an eventual furniture product are categorized for their kind (e.g., legs or backs) and their relationships to other parts of the images are defined (e.g., legs attach here on the design, arms attach here, etc.). The images and textures are likewise associated with each object component (e.g., maple wood texture only goes with legs or arms, not cushions, but cushions have fabric textures that are not present one most legs, etc.).

As a user browses the website and selects a piece of furniture, an arm, a leg, and an associated fabric or fabrics, the associated web call can provide that information to a content management server or high-availability web server (e.g., Akamai or Cloudflare) which can access its individual assets for each component and texture. Then, in real time, those components are intelligently overlaid on one another. However, this framework has relied upon two-dimensional models from 32 different perspectives. It is still limited, particularly for use in augmented reality use cases where an infinite number of perspectives may be necessary (e.g. every possible three-dimensional angle for viewing).

In response, the inventors also have created a system that operates similarly but relies upon untextured three-dimensional models of each element (e.g., each cushion, arm, leg, back, etc.) for a given piece of furniture. The use of a three-dimensional model enables precise perspective from any position relative to a (0, 0, 0) position in a virtual world that is placed at the center of the 3D object. For purposes of this kind of system, it remains necessary to identify the locations on the 3D model to which other objects attach. So, for example, legs only attach to tables (generally) at the four corners. There are obviously exceptions to that rule, but in general that is the case. So, when legs are selected, the positions of those legs relative to that (0, 0, 0) position in an (x, y, z) virtual world are set. Thereafter, any leg of any design and texture may be attached at those positions. This is done for each aspect of each piece.

An associated logic to enable customers (e.g., the furniture manufacturers) to easily format data for this system is likewise necessary. The logic may enable definitions for common types (e.g., legs, or table tops or arms, etc.). Then, the system may guide a typical non-technical user in identifying the components, and their relative position, and enable easily adding or disabling additional components in each slot, along with the associated three-dimensional models.

In much the same way as the two-dimensional version, the three-dimensional models for each component have associated textures. So, for example, a cushion may have cloth or leather textures associated therewith, while wooden or metal legs may have woodgrain, painted, or stained textures.

In this system, a call is made in real-time upon a request for an image to a high-availability server from a web page (or AR headset or application on a tablet PC, for example) for a particular piece of furniture, with particular legs, particular arms, and particular cushions, and having a particular fabric texture. The model is obtained, and the server applies the requested textures in real time, and provides the complete model to the end user. Thereafter, the user may move, rotate, and otherwise interact with that model and texture combination until such time as a different combination is selected.

Alternatively, the model and texture may be applied on the server in real time, such that adjustments are detected (e.g., moving an AR display or moving the model) and the rendering happens on the remote server for that new positional information. Thereafter, an image, with an alpha mask applied along its edges, of the furniture is transmitted. The main benefit of remote rendering is that the transmission of the image will take very little time because it may be sent merely as a 2D image of the rendered 3D model, and the rendering can be completed quickly on specialized hardware, without regard to the particular AR or other device making the request for the object in a particular orientation.

One major benefit of full three-dimensional models is that they may be “placed” virtually within an augmented reality view of a potential purchaser's actual home or space. When placing, they may be very specifically oriented, moved about, and adjusted, unlike the 32-view version reliant upon two-dimensional images.

Description of Apparatus

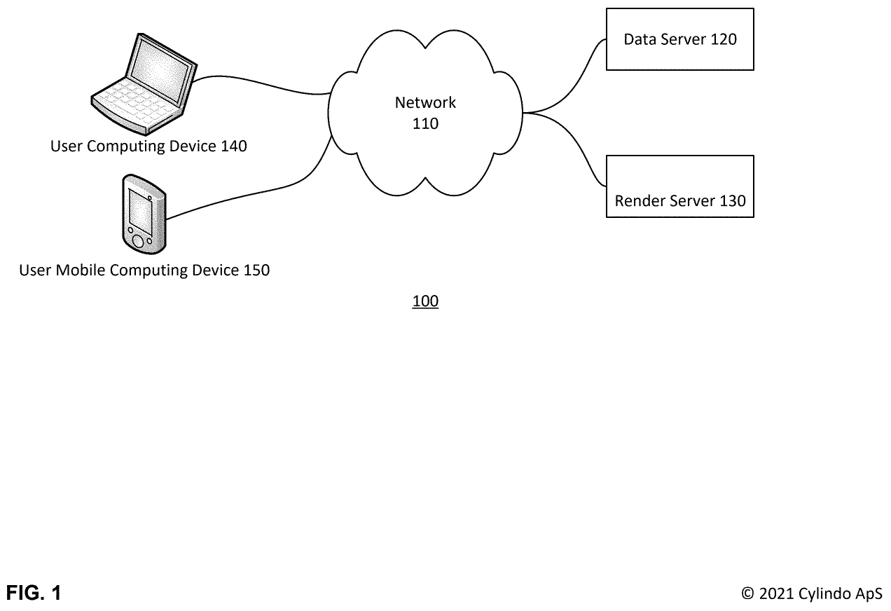

Referring now to FIG. 1, an overview of a system 100 for efficient storage, real-time rendering, and delivery of complex geometric models and textures over the internet is shown. The system 100 includes a data server 120, a render server 130, a user computing device 140, and a user mobile computing device 150 all interconnected by a network 110.

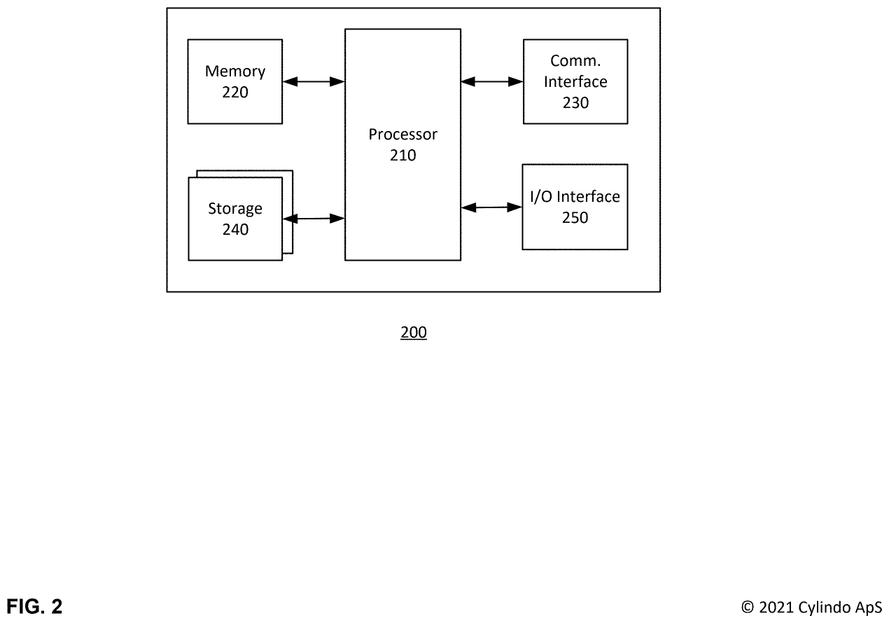

The data server 120 is a computing device (FIG. 2) or a group of computing devices. The data server 120 is used to store three-dimensional models, two-dimensional images (from various perspectives, and any textures associated with the various three-dimensional models. The three-dimensional models, as will be discussed herein, are of various components of the objects to be rendered and delivered. Likewise, the data server 120 may store two-dimensional images of the various components of the objects to be delivered via the internet in the earlier incarnation of this invention involving multiple views (from multiple angles) of each texture combination. The textures are specifically designed to take up less space.

The data server 120 may be self-hosted—meaning operated by a company or entity that enables the functions and systems described herein. Alternatively, the data server 120 may be on a shared resource service such as Amazon AWS or Microsoft Azure. Even more likely, however, the data server 120 is hosted on a high-availability server service—self-hosted or hosted by a service—such as Cloudflare or Akamai and similar services typically reserved for ensuring web pages and other content load quickly when images and video are requested at a very large scale.

The render server 130 is a computing device or a group of computing devices. The render server 130 may be in a single location, but preferably is in many locations so as to serve the maximum number of users throughout the world quickly and efficiently. The render server 130 is a server which is used to render the three-dimensional models and apply textures using one or more shaders. The render server 130 may be integrated with the data server 120 in some implementations. However, it may be preferrable for the render server 130 to incorporate one or more graphics processing units (GPUs) so as to be better equipped to render three-dimensional images with the associated textures. In general, data servers 120 are not equipped with GPUs at all. Specialized hosting services typically incorporate GPUs.

In some implementations, there may not be a render server 130 at all. The textures and models may be provided directly to a requesting device which performs the render operation itself. That is not ideal, particularly for many mobile devices such as phones and tablets, which have weaker or no GPUs for rendering. This option will be discussed in more detail below.

The user computing device 140 is a computing device such as a personal computer, laptop computer, desktop computer or the like. The user computing device 140 is typically a device browsing a website using web browser software or an associated application (e.g. a store or shopping application). The user computing device 140 may be a typical consumer computing device, lacking in any significant specialized capabilities. However, the user computing device 140 may include a GPU or an integrated GPU (e.g. integrated into a single chip with a CPU) that can perform some or all of the rendering operations described herein. In other cases, the user computing device 140 may include no GPU at all, and rendering must take place using a render server 130.

The user mobile computing device 150 is effectively identical to the user computing device, though its form factor may be that of a mobile device. It may, for example, be a mobile phone, a smart phone, a tablet computer, or other, similar device. One unique attribute of the user mobile computing device 150 is that its power may typically be less than the user computing device 140, particularly in rendering three-dimensional models and textures. Though it is increasingly becoming the case that mobile devices are as powerful or more powerful than most laptops or desktop computers, for the moment most user mobile computing devices are less powerful, particularly at three-dimensional rendering.

FIG. 2 is a block diagram of an exemplary computing device 200, which may be a part of the data server 120 or the render server 130 of FIG. 1. As shown in FIG. 2, the computing device 200 includes a processor 210, memory 220, a communications interface 230, along with storage 240, and an input/output interface 250. Some of these elements may or may not be present, depending on the implementation. Further, although these elements are shown independently of one another, each may, in some cases, be integrated into another.

The processor 210 may be or include one or more microprocessors, microcontrollers, digital signal processors, application specific integrated circuits (ASICs), or a systems-on-a-chip (SOCs). The memory 220 may include a combination of volatile and/or non-volatile memory including read-only memory (ROM), static, dynamic, and/or magnetoresistive random access memory (SRAM, DRM, MRAM, respectively), and nonvolatile writable memory such as flash memory.

The memory 220 may store software programs and routines for execution by the processor. These stored software programs may include an operating system software. The operating system may include functions to support the input/output interface 250, such as protocol stacks, coding/decoding, compression/decompression, and encryption/decryption. The stored software programs may include an application or “app” to cause the computing device to perform portions of the processes and functions described herein. The word “memory”, as used herein, explicitly excludes propagating waveforms and transitory signals.

The communications interface 230 may include one or more wired interfaces (e.g. a universal serial bus (USB), high definition multimedia interface (HDMI)), one or more connectors for storage devices such as hard disk drives, flash drives, or proprietary storage solutions. The communications interface 230 may also include a cellular telephone network interface, a wireless local area network (LAN) interface, and/or a wireless personal area network (PAN) interface. A cellular telephone network interface may use one or more cellular data protocols. A wireless LAN interface may use the WiFi® wireless communication protocol or another wireless local area network protocol. A wireless PAN interface may use a limited-range wireless communication protocol such as Bluetooth®, Wi-Fi®, ZigBee®, or some other public or proprietary wireless personal area network protocol. The cellular telephone network interface and/or the wireless LAN interface may be used to communicate with devices external to the computing device 200.

The communications interface 230 may include radio-frequency circuits, analog circuits, digital circuits, one or more antennas, and other hardware, firmware, and software necessary for communicating with external devices. The communications interface 230 may include one or more specialized processors to perform functions such as coding/decoding, compression/decompression, and encryption/decryption as necessary for communicating with external devices using selected communications protocols. The communications interface 230 may rely on the processor 210 to perform some or all of these function in whole or in part.

Storage 240 may be or include non-volatile memory such as hard disk drives, flash memory devices designed for long-term storage, writable media, and proprietary storage media, such as media designed for long-term storage of data. The word “storage”, as used herein, explicitly excludes propagating waveforms and transitory signals.

The input/output interface 250, may include a display and one or more input devices such as a touch screen, keypad, keyboard, stylus or other input devices. The processes and apparatus may be implemented with any computing device. A computing device as used herein refers to any device with a processor, memory and a storage device that may execute instructions including, but not limited to, personal computers, server computers, computing tablets, set top boxes, video game systems, personal video recorders, telephones, personal digital assistants (PDAs), portable computers, and laptop computers. These computing devices may run an operating system, including, for example, variations of the Linux, Microsoft Windows, Symbian, and Apple Mac operating systems.

The techniques may be implemented with machine readable storage media in a storage device included with or otherwise coupled or attached to a computing device 200. That is, the software may be stored in electronic, machine readable media. These storage media include, for example, magnetic media such as hard disks, optical media such as compact disks (CD-ROM and CD-RW) and digital versatile disks (DVD and DVD±RW), flash memory cards, and other storage media. As used herein, a storage device is a device that allows for reading and/or writing to a storage medium. Storage devices include hard disk drives, DVD drives, flash memory devices, and others.

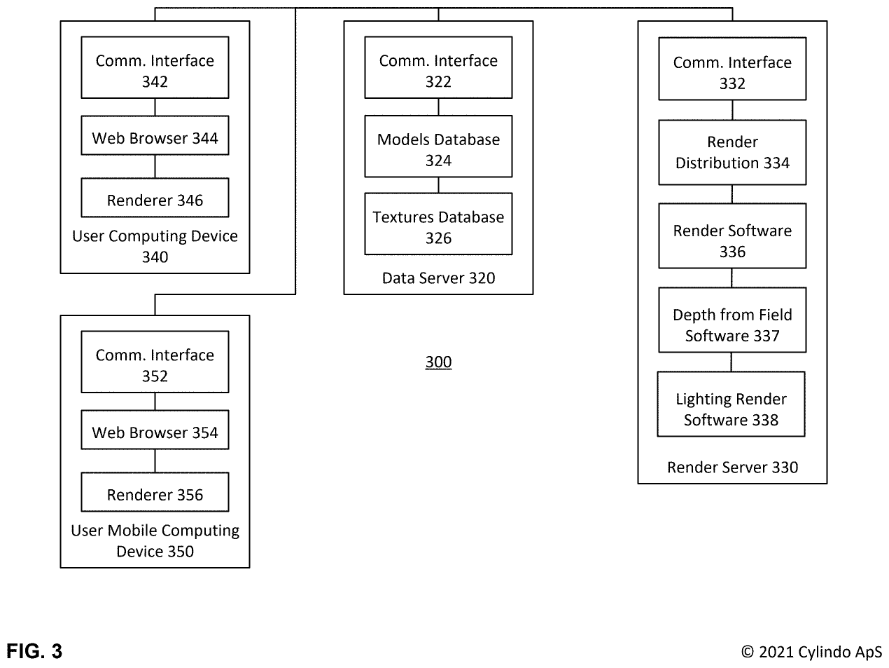

FIG. 3 is a functional block diagram of a system for efficient storage, real-time rendering, and delivery of complex geometric models and textures over the internet. The system includes the data server 320, the render server 330, the user computing device 340, and the user mobile computing device 350.

The data server 320 includes a communications interface 322, a models database 324 and a textures database 326.

The communications interface 322 is an interface for communicating data to and from the data server 320. It may include hardware (e.g. networking hardware such as wireless or wired network adaptors), but it includes software. The communications interface 322 may incorporate standardized network protocols and software, but also may include specialized calls, interfaces, or APIs (application programming interfaces). At a minimum, the communications interface 322 is capable of responding to HTTP, HTTPS, or other requests for data from the models database 324 and the textures database 326 so as to receive the request and act upon it to transmit back models and textures in response.

The models database 324 stores three-dimensional models for the objects. In an example familiar to the inventors, those objects are furnishings. However, the objects could be automobiles, wall hangings, clothing, or other, similar objects with different textures, paint colors, and shapes. The models database 324 may store the models as a series of sub-parts. For example, a chair may be made up of a base, a back, and three or more legs. The sub-parts may be associated with one another such that the models are designed for each sub-part to connect to another sub-part at a particular location or locations. This association of the way in which each sub-part connects with other sub-parts of a whole model may be described as a ruleset. The associated ruleset data, defining these connections between sub-parts may be stored in metadata associated with each sub-part or with an overall model as a whole (e.g. a chair or a desk). The data may preferably be a location in an (x, y, z) axis relative to an origin (0, 0, 0) location for each model.

The textures database 326 stores the textures for the three-dimensional models and/or each sub-part of the three-dimensional models. Textures are a term of art in the computer graphics space which mean images applied to or “wrapped” around three-dimensional images. The textures for a given shape in three-dimensional computer graphics give the object its appearance as a chair, a desk, a wall, and the like. The textures may be relatively simple (e.g. a repeating leather grain so as to not have seams appear in an object applying that texture) or complex (e.g. the pattern of a woven rug). There are numerous techniques for reducing the amount of data necessary for storing and transmitting texture files, including incorporating numerous textures for a given object on a single, flat (two-dimensional) image file.

So, for example, a series of textures may be stored for the legs of a chair or even for a particular type of legs of a chair. For example, a chair may have options for both wooden or metal legs. For wooden legs, the associated textures may be or represent different woods such as maple, oak, and pine, but also different stains for those various woods. For the metal legs, the associated textures may represent brushed chrome, stainless steel, aluminum, chrome, gold, etc. but, when wooden legs are selected, none of those metal leg textures may be shown.

The render server 330 includes a communications interface 332, a render distribution 334, render software 336, depth from field software 337, and lighting render software 338.

The communications interface 332 operates in much the same way as communications interface 322 operates, except the communications interface 332 serves to enable the render server 330 to send and receive render requests and to provide rendered images in response.

The render distribution 334 operates to allocate render requests to the render server 330 or to the user computing device 340 or user mobile computing device 350. The decision primarily may hinge upon the capabilities of the user computing device 340 or user mobile computing device 350 to render the models and textures from the data server 320 or upon the availability or settings associated with the render server 330. Render distribution 334 may provide a render request to the render software 336 or send it to one of the user computing devices.

The render distribution 334 may also manage a load-balancing functionality to allocate the render requests (and the accompanying textures and models) to a particular instance of the render software 336 or to a particular render server 330 based upon availability or current usage of either or both.

The render software 336 is software for converting three-dimensional models and textures into a combined textured model and/or two-dimensional image. Depending on the implementation employed, the render software 336 may return a fully-rendered three-dimensional model to a requesting device (e.g. the user computing device 340) or may return a two-dimensional image of a fully-rendered three-dimensional model with textures and lighting applied from a perspective provided in a render request to the render server 330. The render software may be or include a modified video game rendering software. Common examples of software that may be used for rendering, in whole or in part, are Unity®, the Unreal Engine®, and the CryEngine®. Others may be used or may be more appropriate in given scenarios.

The depth from field software 337 is shown as distinct from the render software 336, but in most instances, they will be integrated with one another. One example of depth from field software 337 is commonly referred to as “ray tracing” software. Ray tracing is a technique employed where a position (e.g. for a viewer or for a light source) may be “ray traced” to any point visible in a three-dimensional environment. Once the ray trace is complete (and in reality ray tracing takes place constantly and is updated in real-time as the model moves), a depth from the place from which the ray trace began is known. This depth is a “depth from field” that may be used as discussed herein. There are also other methods for performing depth from field operations, but ray tracing is becoming the most common.

The depth from field software 337 is used in particular to perform lighting operations (e.g., place a light source here within the space, and calculate the resulting lighting and shadows) and, as discussed more fully below, to perform operations to determine which elements of a multi-part three-dimensional object are visible from a given perspective within a three-dimensional environment. In this way, multi-part models may be appropriately rendered without unnecessarily rendering “invisible” portions of the model and by applying appropriate shadows and lighting transformations.

The lighting render software 338 is shown as distinct from the render software 336, but in most instances will be integrated with the render software 336. The lighting render software 338 is similar to the depth from field software 337, but, in particular, is focused on placing one or more lights within the three-dimensional environment and adjusting the model and its applied textures accordingly. So, for example, planar objects nearby to a light source tend to reflect that light source. Colors brighten and sometimes disappear. Complex software is used to model the interaction of models and in particular textures in response to lighting within the environment and the alter the resulting render. Shadows may also be calculated and created from these light sources. The lighting render software 338 performs these functions.

The user computing device 340 includes a communications interface 342, a web browser 344, and a renderer 346.

The communications interface 342 enables network communications with the internet generally, or other networks, but in particular with the data server 320 and the renderer server 330.

The web browser 344 is a typical web browser software which may be stand-alone or integrated into another application or the operating system itself.

The renderer 346 may or may not be present on the user computing device. In addition, the renderer 346 may be a part of another application or the operating system itself. The renderer 346 can perform the same function as the render software 336, but may operate using the models and textures transmitted to the user computing device 340 from the data server 320, based upon the decision made about distribution by the render distribution 334.

The user mobile computing device 350 includes its own communications interface 352, a web browser 354, and a renderer 356. The user mobile computing device's 350 components operate in much the same way as those of the user computing device 340. That discussion will not be repeated here. The web browser 354 is shown as a separate component, but it may be a part of another application or the mobile device operating system itself.

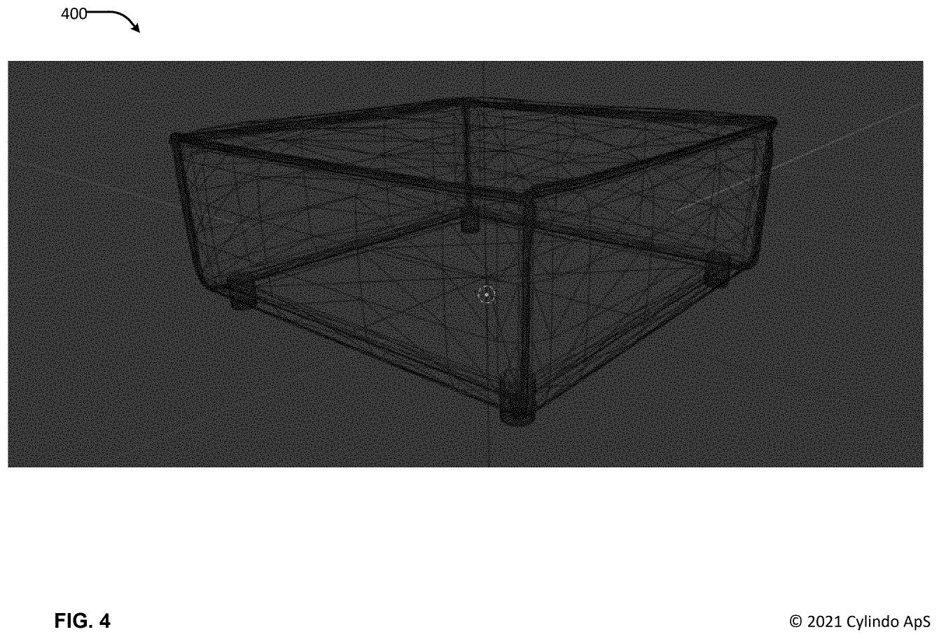

FIG. 4 is an example three-dimensional model 400 of an object presented in wireframe. The model is shown in wireframe without any texture being applied. This is, roughly-speaking, how three-dimensional models are stored in digital form. In most three-dimensional engines, models are stored as a series of vertices that interconnect. These vertices form a grouping of triangles. The faces of these triangles may be “covered” in textures from two-dimensional texture files.

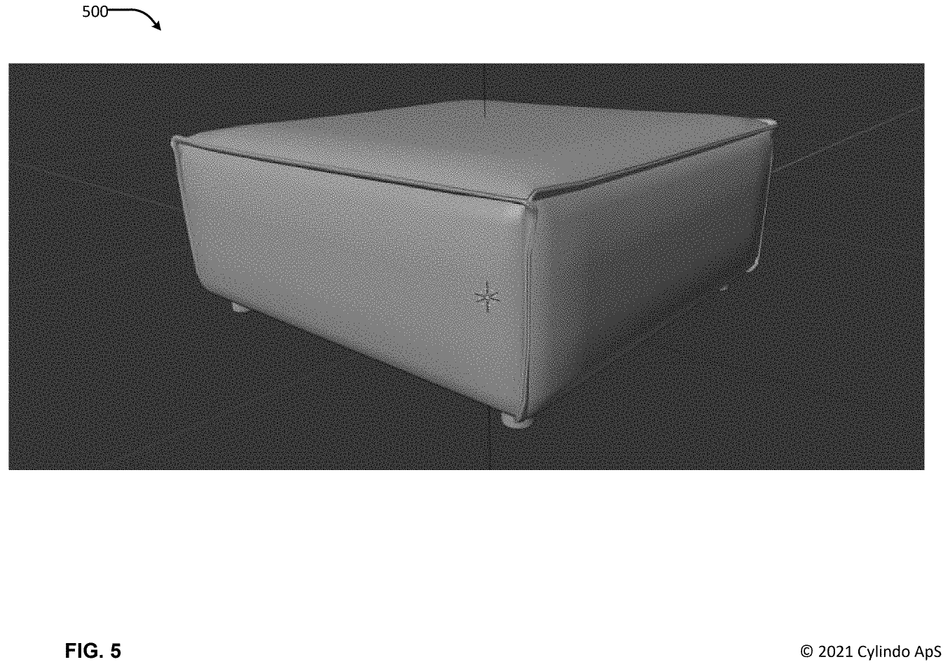

FIG. 5 is an example three-dimensional model 500 with the wireframes interconnected by triangles. This object appears much more like a traditional three-dimensional model, but in an untextured form.

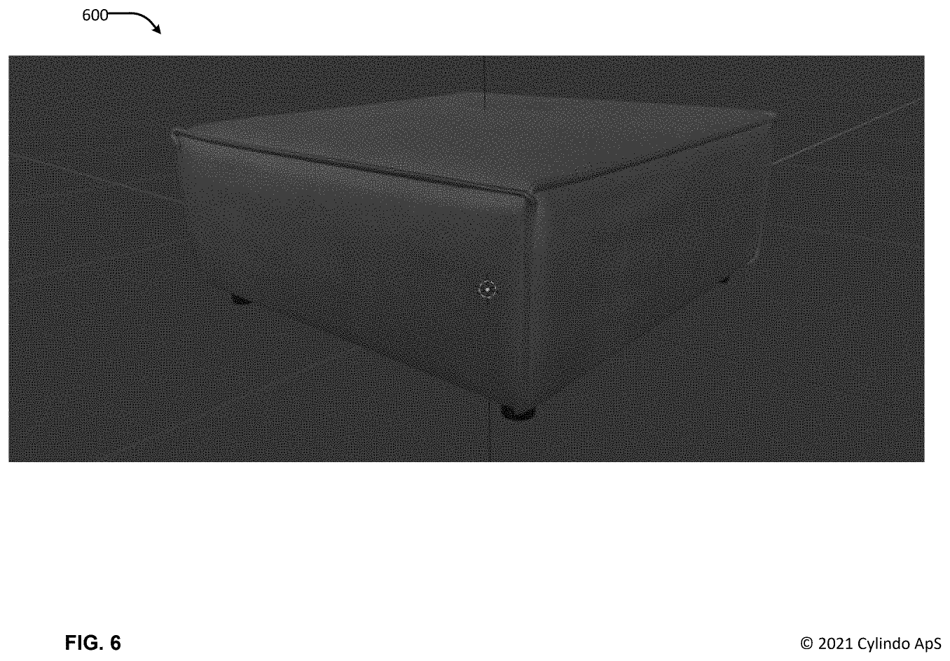

FIG. 6 is an example three-dimensional model 600 covered in a particular material and an associated texture. Here, the object is fully-realized. There is a leather texture to the model 600, it has legs that appear to be made of black metal, and it has realistic lighting applied (e.g. shadows near the base darker than on the top).

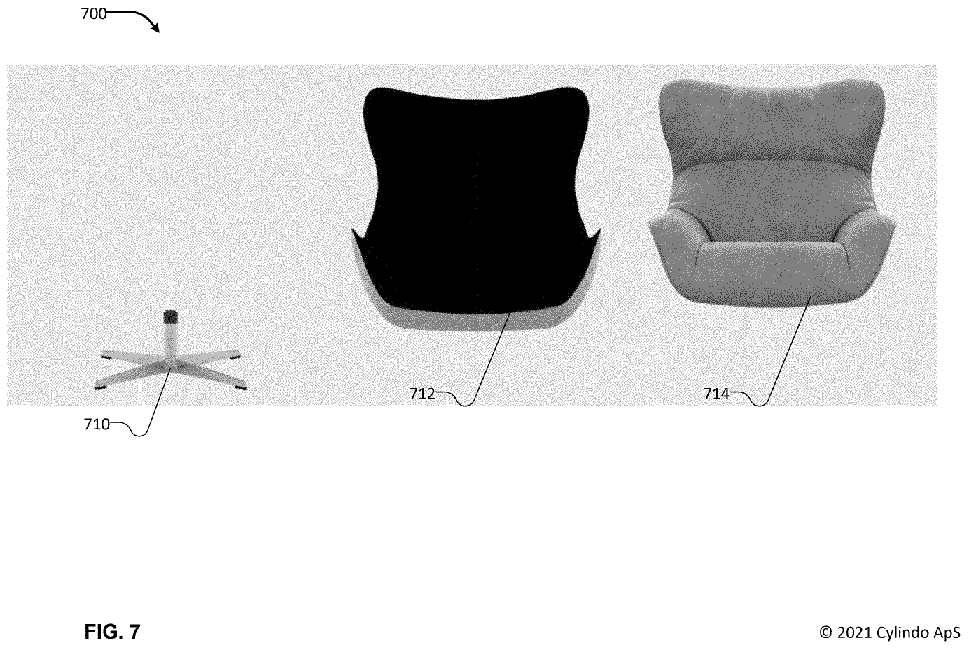

FIG. 7 is an example of the multiple components making up a given object model 700. Because it is impossible to save thirty-two (or any other suitable number) of individual two-dimensional images for a huge number of potential model configurations when these objects are composed of multiple components, the objects themselves may be broken down into multiple, individual three-dimensional sub-parts. Here, the overall object model 700 is composed of sub-parts of a base 710, a backing 712 and a face 714.

The base 710 shown is a four-star pole base. However, the base 710 may be four traditional chair legs or three traditional chair legs, and the materials may be chrome, steel, wood, and other options. Likewise, the backing 712 is shown to be made of cloth. However, different materials may be used, such as leather, or wood (with any number of finishes), plastic, or even metal. Also, the face 714 is shown as made of leather in this particular model. Other models for the face 714 may have cloth, or even particular types of cloth (e.g. corduroy, cotton, linen, etc.) each of which would have their own appearance that would be different from that of the leather face 714 model.

The base may be specifically set forth in associated model metadata to connect at a particular location on the backing 712 model, which may in turn have a particular portion of the face 714 to which it affixes. Thereby, the entire model may be joined from a series of sub-parts. Each sub-part may be separately modeled to create a combined, unique model from each of these sub-parts. Each texture may apply to only certain of the models (e.g. the leather-appearance model only has browns and tans and reds for textures, while the cloth has other colors like blue and red and white). This model and texture separation and sub-parts is preferable, and uses less overall storage space, than storing each option for every part as an entire model.

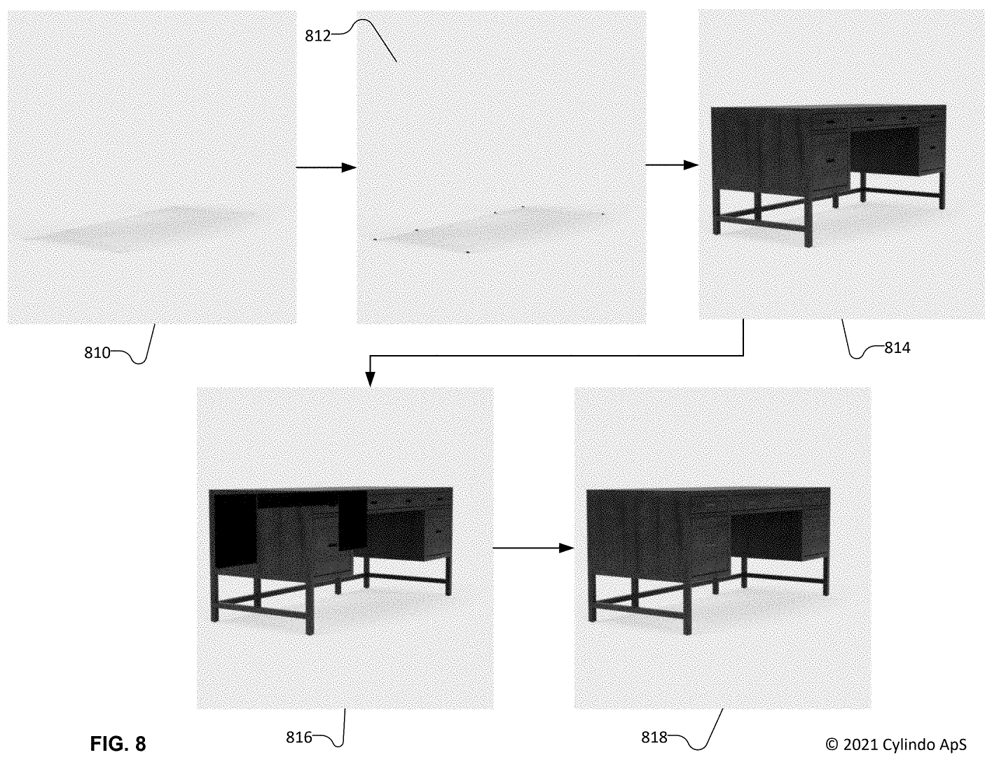

FIG. 8 is an example flow for compositing a two-dimensional image from a series of components as layers. This is the first example of a way to tackle the problem of voluminous data. Here, a series of thirty-two (though it could be more or fewer) perspectives are rendered of an object. To reduce the overall storage impact, from each perspective, only those portions that are visible are stored. So, the first layer 810 (the back-most layer) is merely the shadows that will be cast by the object. The object will always be visible over its shadows, because it is the one casting them. The next layer 812 is the feet layer. They are lower or below every other object, so they are the second back-most layer. The next layer is the angle front layer 814. This is the majority of the object itself. A “back” layer 816 (for the back of the object) is then applied. But, in this perspective, it turns out that it is entirely non-visible, so it is basically irrelevant. The final image 818 is only the visible portions (once each layer is sequentially applied) for the model and its shadow.

One of the drawbacks of this process is that the images are still merely two-dimensional images. There is no possibility of applying dynamic shadows or lighting (e.g., a lighting color or tone). Also, other depth-based tactics are difficult to employ. In addition, because there is no model, a human has to intelligently input each of the individual layers in the appropriate order for the final image 818 to appear appropriately from a given perspective. Otherwise, the shadows can appear over the object itself or other nonsensical results can occur. While this option solves the data-storage problem, a more-elegant, but more complex, three-dimensional approach would be better.

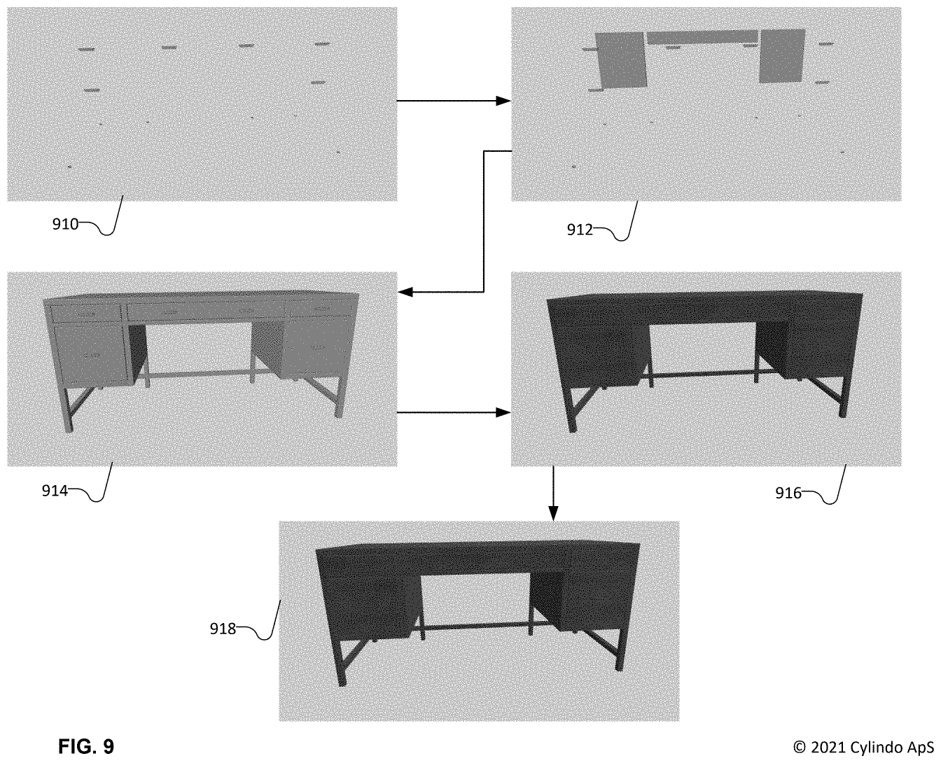

FIG. 9 is an example flow for compositing a three-dimensional, textured model from components as layers. This is an example of such a three-dimensional approach. Under this approach, any angle may be chosen, because it is comprised of fully three-dimensional models making up the sub-parts of the overall model. Here, in FIG. 9, a desk is shown.

The first sub-parts 910 are the handles and feet for the desk. The handles will be in fixed positions, as will the feet. Then, the backing 912 is integrated. It may be fully modelled, but its interior texture need not be applied because it is never visible. Next, the front portion 914 of the model is applied showing the drawers. Then, the texture is applied to each of the integrated sub-parts of this model at 916. Then, the associated textures are applied to the handles at feet at 918 to generate the final model.

Uniquely, this model may be rotated. Its shadows may be dynamically created by the renderer once the model is complete. Object interaction is enabled whereby this model may appropriately “sit” in a given area, or respond to interactions with different sub-parts (e.g. swapping legs, tops, materials). This object may be placed (in augmented reality) within a real space, with current lighting even simulated by the renderer to make the object appear as closely as possible to its position in the real world. The three-dimensional model system is much more flexible and powerful, while having virtually all of the space-saving benefits of the original two-dimensional image model. Further benefits will be discussed below.

Description of Processes

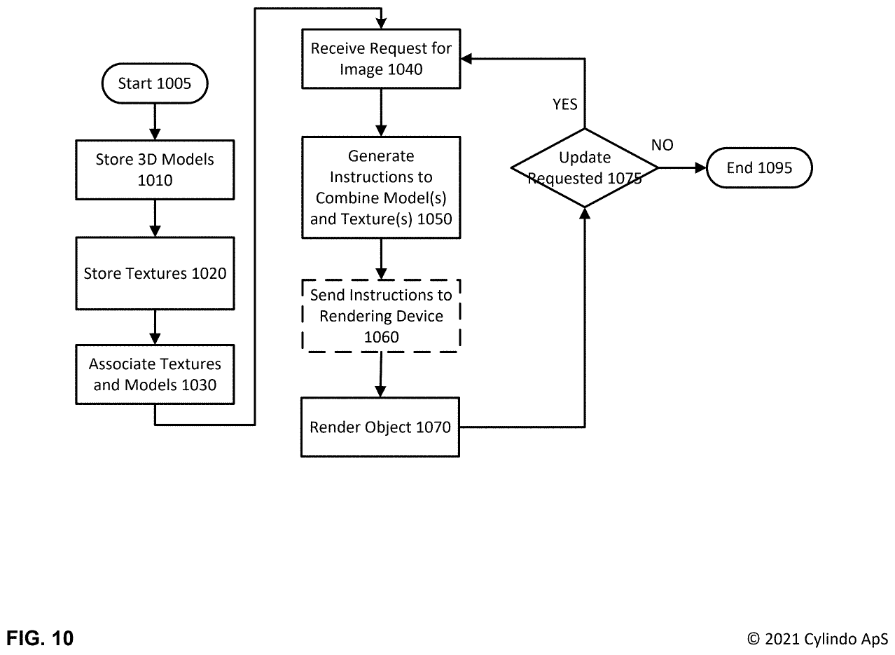

Referring now to FIG. 10, a flowchart of a process for efficient storage, real-time rendering, and delivery of complex geometric models and textures over the internet. The flow chart has both a start 1005 and an end 1095, but the process may be cyclical in nature.

Following the start 1005, the process begins with the storage of the three-dimensional models at 1010. Here, the models have been created for each sub-part of each object that is desired to be modeled and textured using this system. For an automobile, this may be the exterior, windows, doors, wheels, any optional spoilers or tonneau covers and any exterior badging. For furniture, it may be legs, arms, backs, seats, cushions, and may also include the physical portion of any texture having a shape (e.g. grain of leather, cloth appearance, etc.). The storage of those models at 1010 may also involve storage of associated metadata describing the way in which each of the sub-parts of a given entire object model are interlinked (e.g. legs attach here, arms attach here, etc.).

Next, the textures are stored at 1020. Here, the corresponding images making up the textures (e.g. woodgrain, leather colors, cloth colors) are stored for each model and for each sub-part of a given model of an object. Much like the way in which the parts interlink, metadata may be stored along with these textures that indicates the way in which the textures are applied, and to which components or sub-parts they apply. Woodgrain, for example, does not apply to a seat cushion, but may apply to the legs of a couch.

This association of textures and models may take place at 1030 through interaction by a user with a user interface, or may be pre-programmed into the models themselves. There may be a conversion process from a model or series of models and textures to automatically generate a different format as required for the storage taking place at steps 1010 and 1020 to thereby associate those textures and models at 1030. Once this is complete, the data server 120 (FIG. 1) is ready to respond to requests for models and textures.

Next, a request for an image is received at 1040. At this step, a web browser has requested a particular set of characteristics for a model of an object (e.g. a chair) and it has been received by, for example, a render server 130 (FIG. 1). This request may likewise include a particular orientation of the object or perspective and may likewise include a desired lighting color, tone, and position in space relative to the object to be modeled.

Next, instructions are created to combine the sub-parts of the model (e.g. the model(s)) and associated textures at 1050. These instructions inform a renderer in the way the sub-parts are interconnected, the textures to apply to each sub-part, and the positioning of the lighting and camera relative to the object.

Optionally, these instructions may be sent to a remote rendering device 1060. This could be the render server 130 (FIG. 1) or it could be sent as a part of the response back to the requesting user computing device 140 (FIG. 1). The rendering may take place right on the same device that stores the models and textures and that generated the instructions at 1050. If the rendering is to take place remote from the server where the model(s) and texture(s) are stored, then the necessary model(s) and texture(s) may be sent along with the instructions. This also can aid in easy re-rendering (e.g. slight movements or changes to position) for the object by a remote renderer.

Wherever the render is to take place, preferably a render server, the object is rendered at 1070. Here, all of the request, model(s) and texture(s) are considered and the overall model is rendered as a two-dimensional image (e.g. an image suitable for transport to the requesting device such as a web browser or augmented reality application). The rendered object may then be transmitted to that device (if necessary) or may be displayed on the device if transmission is unnecessary.

If an update is requested (e.g. the model or perspective is moved or the lighting changes or the components changes, such as new legs or back) at 1075 (“yes” at 1075), then this requested change is processed much as the original request for image at 1040.

If there are no updates requested at 1075 (“no” at 1075), then the process ends at 1095.

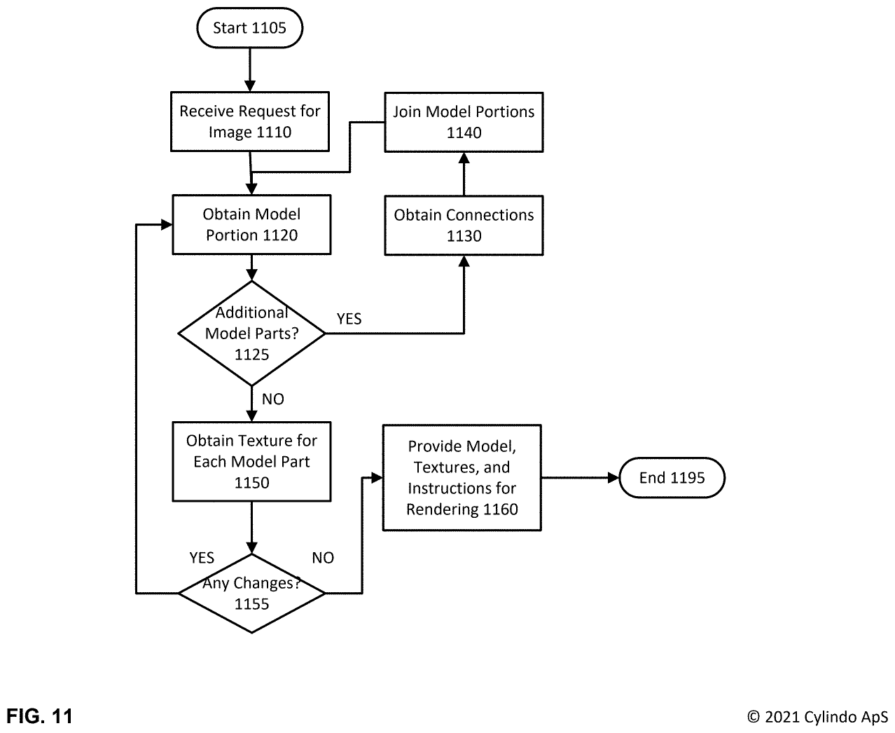

FIG. 11 is a flowchart of a process for generating dynamic three-dimensional models and textures. The flow chart has both a start 1105 and an end 1195, but the process may be cyclical in nature. This process begins following start 1105 with receipt of a request for an image 1110, much as in FIG. 10. The request may identify all of the sub-parts desired and the associated desired textures for a given model.

Thereafter, the first step is to obtain an associated model portion at 1120. This may be the legs of a given chair, or the arms. Then, a determination is made at 1125 whether additional model parts are needed. If yes (e.g. a chair is not arms alone), then the associated connections for the part are obtained at 1130. This may be from metadata associated with the request itself received at 1110 or may be obtained from the model portion obtained at 1120. Any model portions obtained are also joined at 1140 to create a combined model making up the two (or more) model portions.

Again, the system determines whether there are additional model parts at 1125. If so (“yes” at 1125), then the further connections are obtained.

If not, or once the model is complete (“no” at 1125), then the textures requested in the request are obtained for each model part at 1150. Here, the textures for each sub-part are obtained. These may be woodgrain for legs, textured cloth of a certain color for the arms and seat cushions, and a pattern for a backing.

Next, a determination is made whether there are any changes to the model at 1155. Here, if there are changes (“yes” at 1155), then the process may begin again with obtaining the model portion and any connected portions, etc. If there are no changes (“no” at 1155), then the rendering instructions are provided including the model, textures and instructions for the way in which those components are joined to one another for rendering at 1160.

As discussed above, the rendering may take place on the same device or on a user device. The model, textures and instructions are provided to the device that needs to perform the rendering.

The process then ends at 1195.

Using these models, rather than a series of two-dimensional images enables secondary effects, such as depth from camera-based compositing. For a given perspective in the two-dimensional set of images, for each of the 32 perspectives, every pixel of every component (e.g., each leg, chair, arm, tabletop, etc.) must be individually identified as “visible” or “not-visible”from a given perspective. So, for example, part of a leg may be obscured by a skirt on a chair, or the chair cushion itself (given a perspective), etc. But, there may be thousands of permutations of each design, and performing this individual flagging for each component can be time-consuming.

Using the three-dimensional version of this process, a depth-from-camera algorithm (e.g., ray tracing) easily can be used to determine which pixels are “closest” to the camera when it comes to render time (i.e., time to create the two-dimensional image that is passed over the web). In this way, the data behind the other data (i.e., the data with a greater depth-from-camera may be masked out. This enables the three-dimensional render to merely render those portions of the design (e.g., from the given perspective) that are relevant for the requested view (e.g., not showing the underneath of a chair or a part of a leg that is not visible). This speeds up render time and enables the eventual two-dimensional image of the object to be transmitted faster to a requesting user.

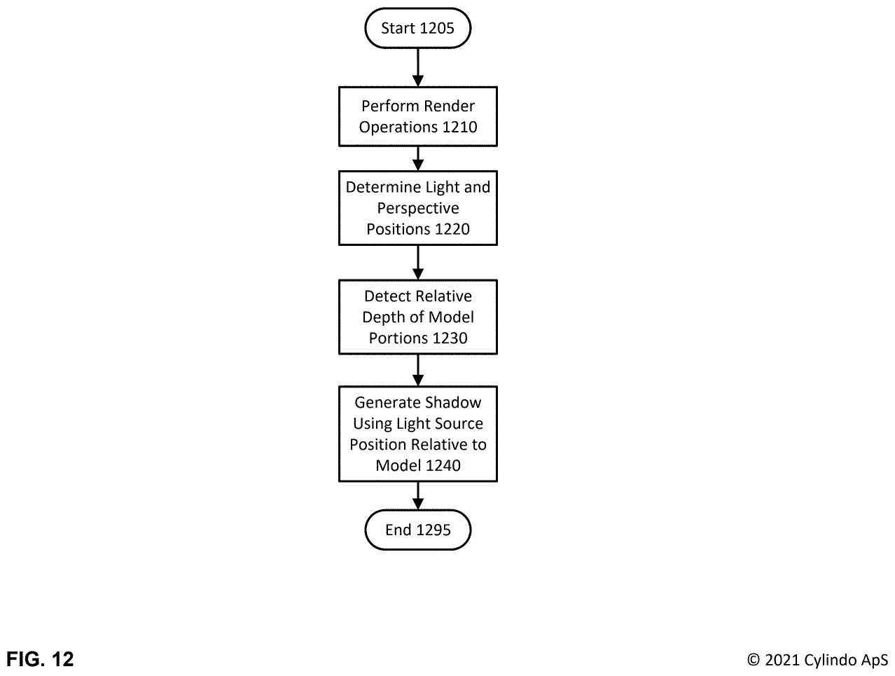

FIG. 12 is a flowchart of a process for applying realistic lighting effects to a generated three-dimensional model. The flow chart has both a start 1205 and an end 1295, but the process may be cyclical in nature.

This process may be called on-demand rendering of shadows and illumination. Using a similar technology to the depth from camera-based compositing, the application of textures to three-dimensional models results in “generic-looking” models. The models do not consider interactions with the room in which they appear, or other objects that may be placed on those models (e.g., a brightly-colored pillow or shadow cast by the arm on the base of the couch, etc.). To combat this, and to provide a more realistic application of expected light interactions, ray tracing or similar technology may be used to dynamically “place” light into a space in which the object appears. Then, the visible rays of light may automatically interact with the model (e.g., after its position is determined and its textures and components selected). So, for contrast objects like light couches or reflections on tables and nearby dark objects, the ray tracing will make those light interactions that human vision experiences more lifelike. Similarly, a light perspective will enable shadows to intelligently be cast in the image in a given two-dimensional render of a piece of furniture or the like. In some cases, a light source may be estimated from a real-time image captured by an augmented reality device to provide that light-source relationship information to the render pipeline. The ray tracing technology is applied at the render stage to provide a more realistic image, from the selected perspective, of the model and textures.

To avoid application of ray tracing to all aspects of the model, the depth-from-camera algorithm can be used to mask out the portions of the model and texture which are not visible from the chosen perspective prior to application of the ray tracing technology. In that way, the model and textures may be significantly simplified for application of ray tracing. Basically, only visible portions of the furniture (or other object) need have ray tracing applied. The ray tracing may even start from those visible pixel portions, rather than a reflecting light from a particular source, as those pixels may be easier to identify using the depth-from-camera algorithms.

Following the start 1205, the process begins with performance of the render operation at 1210. Here, the model is rendered according to FIGS. 10 and 11.

Thereafter, light and perspective positions are determined. Here, a virtual “camera” is placed in the world according to the request for modelling received. There may be a typical neutral position for this camera, or it may be incredibly specific (e.g. for augmented reality operations). Likewise, light may be evenly sourced from above or from the front. Alternatively, lighting may be applied in a special way from an odd angle. This may be a part of the instructions or may be automatically detected by a requesting device (e.g. a user mobile computing device 150, FIG. 1).

Next, the relative depth of model portions is determined at 1230. Here, there may be multiple determinations made. First, depth from field from the position of the camera itself may be determined. In this way, the renderer can determine which elements of the model are simply not visible at all. If they are not visible, then they need not be rendered at all, and they can be masked out of further consideration. In addition, a depth from field determination may be made from the one or more light sources to generate appropriate lighting for the model from those sources (relative to the camera location).

Finally, the shadow and light sources are generated and positioned relative of the model at 1240. Here, the lighting effects can be applied intelligently using the depth from field information. Shadows can be appropriately positioned for a given room (or virtual room) based upon the camera and lighting positions. This may be particularly useful for textured objects, or unusual model shapes for certain objects. The shadows may cast appropriately by using this depth from field from multiple perspectives (e.g. light and camera).

Finally, the process ends at 1295.

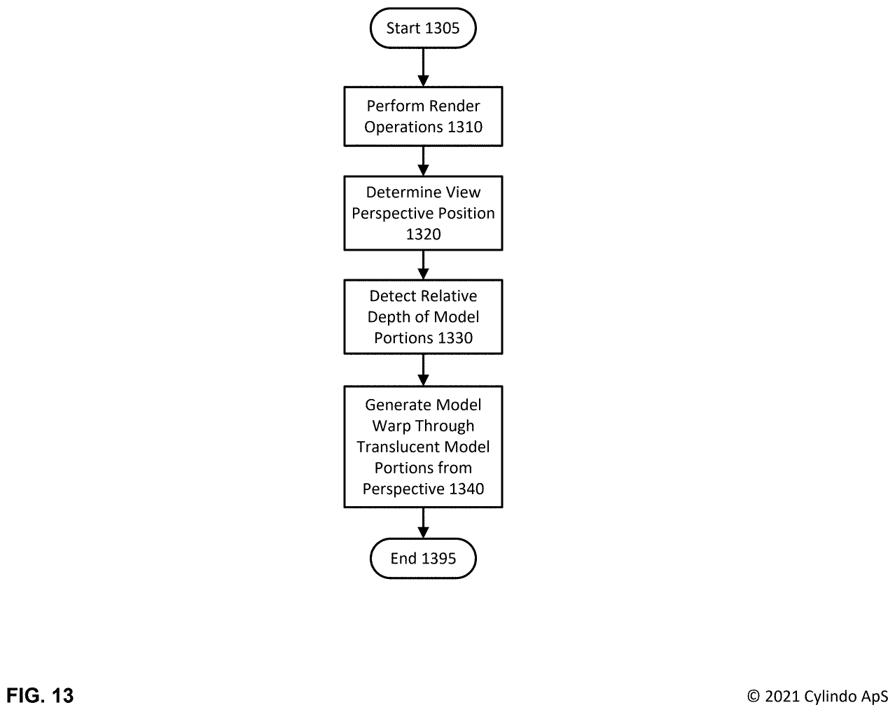

FIG. 13 is a flowchart of a process for applying appropriate visual warp to translucent and transparent three-dimensional models. The flow chart has both a start 1305 and an end 1395, but the process may be cyclical in nature.

Transparent or translucent objects may incorrectly interact with real-time rendered objects. So, for example, a glass vase or drinking glass or nearby curved window may throw shadows and may bend or otherwise interact with a three-dimensional model to which a texture has been applied. At the render stage, that information may be incorporated. The render may take place as usual, but as a final pass, ray tracing may be applied to the model to detect transparent, translucent or partially transparent or translucent objects and to cause appropriate interaction of light with the selected texture and model. Depth from field is relevant here, as distant objects are just blurrier or disrupted more than objects nearby to the transparent or translucent surface. But, ray tracing enables those interactions to be “baked into” the image that is transmitted back to a requesting user following a real-time render of that three-dimensional model.

This likewise may be done intelligently, meaning the pixels that have no transparency or translucency can be ignored for purposes of this ray tracing. As is generally known, ray tracing is a processor-intensive prospect, so it slows rendering down. To perform this function, the pixels that do not involve transparency may be detected (or pre-determined) and those may be processed normally. Then, only the transparent pixels may be processed using the ray tracing technology. This significantly cuts render time, and still enables the appropriate interaction of the light and transparency with the three-dimensional model before it is rendered and sent to a requesting user.

Here, following the start 1305, the process begins with performance of render operations at 1310, determining perspective view information at 1320, and detecting relative depth of model portions 1330. These steps are similar to those described in FIG. 12.

However, at 1330, transparent portions may be detected specifically. They may have an associated transparency flag or other setting identifying those pixels as such at render time. Those pixels may be purely transparent or may be refractory (e.g. curved glass).

For any detected curved glass or similar transparency (colored glass could alter this as well), model warp for objects detected to be “behind” that glass may be applied using ray tracing or similar depth from field technology at 1340. The tracing of light through even warped glass is one of the applications of depth from field and ray tracing technology. But, only those portions flagged as transparent or semi-transparent need be rendered this way. This is particularly useful for situations in which augmented reality may be used and an object on a table (e.g. a glass vase) is involved. The object may be realistically warped using ray tracing.

The process then ends at 1395.

### CLOSING COMMENTS

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

1. A system for real-time compositing, rendering and delivery of complex geometric models and textures, comprising:
first data storage for storing a plurality of three-dimensional models of at least two sub-parts of a whole three-dimensional object, the plurality of three-dimensional models combinable in a pre-determined fashion based upon a ruleset into the whole three-dimensional object;
second data storage for storing a plurality of image textures for each of the plurality of three-dimensional models; and
a computing device for:
receiving instructions from a user, the instructions comprising a selection of at least two of the plurality of three-dimensional models, each of the at least two of the plurality of three-dimensional models being one of the at least two sub-parts of the whole three-dimensional object,
wherein the instructions further comprise a selection of at least one of the plurality of image textures for each of the at least two of the plurality of three-dimensional models making up the whole three-dimensional object; and
generating the whole three-dimensional object comprised of the at least one of the plurality of image textures for each of the at least two of the plurality of three-dimensional models applied according to the instructions to the at least two of the plurality of three-dimensional models.

2. The system of claim 1 wherein the user providing the instructions is using a second computing device remote from the computing device.

3. The system of claim 1 wherein the generating the whole three-dimensional object comprises:
rendering the three-dimensional object using a graphics processor to generate a two-dimensional image of the three-dimensional object from a perspective within three-dimensional space, the perspective included within the instructions; and
transmitting the two-dimensional image to a second computing device remote from the computing device over a network for display on the second computing device.

4. The system of claim 1 wherein the generating the whole three-dimensional object comprises:
transmitting the at least two of the plurality of three-dimensional models making up the whole three-dimensional object and the at least one of the plurality of image textures for each of the at least two of the plurality of three-dimensional models making up the whole three-dimensional object over a network to a second computing device along with rendering instructions;
rendering the whole three-dimensional object using the second computing device to thereby generate a two-dimensional image of the whole three-dimensional object from a perspective within three-dimensional space, the perspective provided by the second computing device and updated as desired by the user of the second computing device; and
displaying the rendered whole three-dimensional object on a display.

5. The system of claim 1 wherein the generating the whole three-dimensional object comprises:
compositing the at least two of the plurality of three-dimensional models making up the whole three-dimensional object from a perspective;
detecting a relative depth of the at least two of the plurality of three-dimensional models making up the whole three-dimensional object from the perspective to thereby determine which portions of the at least two of the plurality of three-dimensional models overlay other portions based upon the perspective; and
identifying the other portions in the instructions as not necessary to be rendered.

6. The system of claim 1 wherein the generating the whole three-dimensional object comprises:
compositing the at least two of the plurality of three-dimensional models making up the whole three-dimensional object;
detecting a relative depth of the at least two of the plurality of three-dimensional models making up the whole three-dimensional object from a perspective comprising a light source; and
generating shadows based upon the relative depth of the at least two of the plurality of three-dimensional models making up the whole three-dimensional object and the perspective of the light source.

7. The system of claim 1 wherein the generating the whole three-dimensional object comprises:
compositing the at least two of the plurality of three-dimensional models making up the whole three-dimensional object;
detecting a relative depth of the at least two of the plurality of three-dimensional models making up the whole three-dimensional object from a perspective;
tracing light transmission through one or more transparent or translucent portions of the whole three-dimensional object; and
generating distortion of the whole three-dimensional object or an object behind the whole three-dimensional object, based upon the light transmission traced through the translucent portions of the whole three-dimensional object.

8. A non-volatile machine-readable medium storing a program having instructions which when executed by a processor will cause the processor to:
store a plurality of three-dimensional models of at least two sub-parts of a whole three-dimensional object in a first data storage, the plurality of three-dimensional models combinable in a pre-determined fashion based upon a ruleset into the whole three-dimensional object;
store a plurality of image textures for each of the plurality of three-dimensional models in a second data storage;
receive instructions from a user, the instructions comprising a selection of at least two of the plurality of three-dimensional models, each of the at least two of the plurality of three-dimensional models being one of the at least two sub-parts of the whole three-dimensional object,
wherein the instructions further comprise a selection of at least one of the plurality of image textures for each of the at least two of the plurality of three-dimensional models making up the whole three-dimensional object; and
generate the whole three-dimensional object comprised of the at least one of the plurality of image textures for each of the at least two of the plurality of three-dimensional models applied according to the instructions to the at least two of the plurality of three-dimensional models.

9. The apparatus of claim 8 wherein the user providing the instructions uses a computing device remote from the processor.

10. The apparatus of claim 8 wherein the generating the whole three-dimensional object comprises:
rendering the whole three-dimensional object using a graphics processor to thereby generate a two-dimensional image of the whole three-dimensional object from a perspective within three-dimensional space, the perspective included within the instructions; and
transmitting the two-dimensional image to a second computing device remote from the computing device over a network for subsequent display on the second computing device.

11. The apparatus of claim 8 wherein the generating the whole three-dimensional object comprises:
transmitting the at least two of the plurality of three-dimensional models making up the whole three-dimensional object and the at least one of the plurality of image textures for each of the at least two of the plurality of three-dimensional models making up the whole three-dimensional object over a network to a second computing device along with rendering instructions;
rendering the three-dimensional object using the second computing device to thereby generate a two-dimensional image of the whole three-dimensional object from a perspective within three-dimensional space, the perspective provided by the second computing device and updated as desired by the user of the second computing device; and
displaying the rendered whole three-dimensional object on a display.

12. The apparatus of claim 8 wherein the generating the whole three-dimensional object comprises:
compositing the at least two of the plurality of three-dimensional models making up the whole three-dimensional object from a perspective;
detecting a relative depth of the at least two of the plurality of three-dimensional models making up the whole three-dimensional object from the perspective to determine which portions of the at least two of the plurality of three-dimensional models overlay other portions based upon the perspective; and
identifying the other portions in the instructions as not necessary to be rendered.

13. The apparatus of claim 8 wherein the generating the whole three-dimensional object comprises:
compositing the at least two of the plurality of three-dimensional models making up the whole three-dimensional object;
detecting a relative depth of the at least two of the plurality of three-dimensional models making up the whole three-dimensional object from a perspective comprising a light source; and
generating shadows based upon the relative depth of the at least two of the plurality of three-dimensional models making up the whole three-dimensional object and the perspective of the light source.

14. The apparatus of claim 8 wherein the generating the whole three-dimensional object comprises:
compositing the at least two of the plurality of three-dimensional models making up the whole three-dimensional object;
detecting a relative depth of the at least two of the plurality of three-dimensional models making up the whole three-dimensional object from a perspective;
tracing light transmission through one or more transparent or translucent portions of the whole three-dimensional object; and
generating distortion of the whole three-dimensional object or an object behind the whole three-dimensional object, based upon the light transmission traced through the translucent portions of the whole three-dimensional object.

15. The apparatus of claim 8 further comprising:
the processor; and
a memory,
wherein the processor and the memory comprise circuits and software for performing the instructions on the storage medium.

16. A method for real-time compositing, rendering and delivery of complex geometric models and textures, comprising:
storing a plurality of three-dimensional models of at least two sub-parts of a whole three-dimensional object in a first data storage, the plurality of three-dimensional models combinable in a pre-determined fashion based upon a ruleset into the whole three-dimensional object;
storing a plurality of image textures for each of the plurality of three-dimensional models in a second data storage;
receiving instructions from a user, the instructions comprising a selection of at least two of the plurality of three-dimensional models, each of the at least two of the plurality of three-dimensional models being one of the at least two sub-parts of the whole three-dimensional object,
wherein the instructions further comprise a selection of at least one of the plurality of image textures for each of the at least two of the plurality of three-dimensional models making up the whole three-dimensional object; and
generating the whole three-dimensional object comprised of the at least one of the plurality of image textures for each of the at least two of the plurality of three-dimensional models applied according to the instructions to the at least two of the plurality of three-dimensional models.

17. The method of claim 16 wherein the generating the whole three-dimensional object comprises:
transmitting the at least two of the plurality of three-dimensional models making up the whole three-dimensional object and the at least one of the plurality of image textures for each of the at least two of the plurality of three-dimensional models making up the whole three-dimensional object over a network to a second computing device along with rendering instructions;
rendering the three-dimensional object using the second computing device to thereby generate a two-dimensional image of the whole three-dimensional object from a perspective within three-dimensional space, the perspective provided by the second computing device and updated as desired by the user of the second computing device; and
displaying the rendered whole three-dimensional object on a display.

18. The method of claim 16 wherein the generating the whole three-dimensional object comprises:
compositing the at least two of the plurality of three-dimensional models making up the whole three-dimensional object from a perspective;
detecting a relative depth of the at least two of the plurality of three-dimensional models making up the whole three-dimensional object from the perspective to thereby determine which portions of the at least two of the plurality of three-dimensional models overlay other portions based upon the perspective; and
identifying the other portions in the instructions as not necessary to be rendered.

19. The method of claim 16 wherein the generating the whole three-dimensional object comprises:
compositing the at least two of the plurality of three-dimensional models making up the whole three-dimensional object;
detecting a relative depth of the at least two of the plurality of three-dimensional models making up the whole three-dimensional object from a perspective comprising a light source; and
generating shadows based upon the relative depth of the at least two of the plurality of three-dimensional models making up the whole three-dimensional object and the perspective of the light source.

20. The method of claim 16 wherein the generating the whole three-dimensional object comprises:
compositing the at least two of the plurality of three-dimensional models making up the whole three-dimensional object;
detecting a relative depth of the at least two of the plurality of three-dimensional models making up the whole three-dimensional object from a perspective;
tracing light transmission through one or more transparent or translucent portions of the whole three-dimensional object; and
generating distortion of the whole three-dimensional object or an object behind the whole three-dimensional object, based upon the light transmission traced through the translucent portions of the whole three-dimensional object.
